(19) United States
(12) Patent Application Publication
(10) Pub. No.: US 2024/0345855 A1
(43) Pub. Date: Oct. 17, 2024

(54) APPLICATION STARTING METHOD, ELECTRONIC DEVICE, AND NON-TRANSITORY COMPUTER-READABLE STORAGE MEDIUM

(71) Applicant: GUANGDONG OPPO MOBILE TELECOMMUNICATIONS CORP., LTD., Dongguan (CN)

(72) Inventors: Zhaojin WANG, Dongguan (CN); Long CHEN, Dongguan (CN); Yulin YANG, Dongguan (CN); Haiyun TANG, Dongguan (CN); Lifeng CHEN, Dongguan (CN)

(73) Assignee: GUANGDONG OPPO MOBILE TELECOMMUNICATIONS CORP., LTD., Dongguan (CN)

(21) Appl. No.: 18/757,369

(22) Filed: Jun. 27, 2024

Related U.S. Application Data
(63) Continuation of application No. PCT/CN2022/130774, filed on Nov. 9, 2022.

(30) Foreign Application Priority Data
Dec. 27, 2021 (CN) 202111612937.0

(51) Int. Cl. G06F 9/451; G06F 3/04842; G06T 13/80

(52) U.S. Cl. CPC G06F 9/451; G06F 3/04842; G06T 13/80

(57) ABSTRACT

An application starting method is applicable to an electronic device, the electronic device supports running of a first system and a second system, and the method includes: sending, by the first system, an application starting message to the second system, drawing, by the second system, a target interface based on the application starting message, where the target interface is the system interface of the first system or an application interface of the target application run by the second system; displaying, by the second system, the target interface in response to drawing of the target interface being completed. An electronic device, and a non-transitory computer-readable storage medium are further provided.

### CROSS REFERENCE TO RELATED APPLICATIONS

The present application is a continuation-application of International (PCT) Patent Application No. PCT/CN2022/130774, filed Nov. 9, 2022, which claims foreign priority to Chinese Patent Application No. 202111612937.0 filed Dec. 27, 2021, the disclosures of which are herein incorporated by reference in their entireties.

### TECHNICAL FIELD

The present disclosure relates to the field of electronic devices, and in particular to an application starting method, an electronic device, and a non-transitory computer-readable storage medium.

### BACKGROUND

With the continuous development of science and technology, more and more electronic devices with different functions emerge at the historic moment, which brings many conveniences to a user's daily life.

In addition to achieve some simple functions, such as checking time and setting alarm clock, the electronic device may also achieve some complex functions through an installed application. For example, a user may communicate instantly through an instant messaging application installed in the electronic device, and monitor sleep quality in real time through a sleep-monitoring application installed in the electronic device.

### SUMMARY OF THE DISCLOSURE

According to a first aspect, some embodiments of the present disclosure provide an application starting method applicable to an electronic device. The electronic device supports running of a first system and a second system. The method includes: sending, by the first system, an application starting message to the second system; drawing, by the second system, a target interface based on the application starting message, where the target interface is the system interface of the first system or an application interface of the target application run by the second system; displaying, by the second system, the target interface in response to drawing of the target interface being completed.

According to a second aspect, some embodiments of the present disclosure provide an electronic device. The electronic device includes a processor and a memory. The memory stores at least one program, and the at least one program is configured to be execute by the processor to perform the application starting method described in the foregoing aspect.

According to a third aspect, some embodiments of the present disclosure provide a non-transitory computer-readable storage medium. The storage medium stores at least one program, and the at least one program is configured to be execute by a processor to perform the application starting method described in the foregoing aspect.

### BRIEF DESCRIPTION OF THE DRAWINGS

FIG. 1 is a schematic diagram of an interface of an application starting process in the related art.

FIG. 2 is a schematic diagram of a dual-core communication software framework corresponding to a second processor according to an embodiment of the present disclosure.

FIG. 3 is a schematic diagram of a dual-core communication software framework corresponding to a first processor according to an embodiment of the present disclosure

FIG. 4 is a flowchart of an application starting method according to an embodiment of the present disclosure.

FIG. 5 is a principle schematic diagram of an application starting method according to an embodiment of the present disclosure.

FIG. 6 is a flowchart of an application starting method according to another embodiment of the present disclosure.

FIG. 7 is a schematic diagram of an interface of an application starting process according to an embodiment of the present disclosure.

FIG. 8 a sequence diagram of a system interaction during an application starting process according to yet another embodiment of the present disclosure.

FIG. 9 is a flowchart of an application starting method according to yet another embodiment of the present disclosure.

FIG. 10 is a schematic diagram of an interface of an application starting process according to an embodiment of the present disclosure.

FIG. 11 is a sequence diagram of a system interaction during an application starting process according to another embodiment of the present disclosure.

FIG. 12 a structural block diagram of an application starting apparatus according to another embodiment of the present disclosure.

FIG. 13 is a structural block diagram of an electronic device according to an embodiment of the present disclosure.

### DETAILED DESCRIPTION

In order to make the purpose, technical solutions and advantages of the present disclosure clearer, the present disclosure will be further described in detail below with reference to the accompanying drawings.

In the present disclosure, the term “multiple” or “a plurality of” means two or more. The term “and/or” may illustrate an association relationship of associated objects, indicating that three relationships can exist. For example, A and/or B may indicate: the existence of A alone, the existence of both A and B, and the existence of B alone. In addition, the character “/” may generally indicate an “or” relationship between the former object and latter object.

In the related art, an electronic device is configured with a single processor that processes, by running an operating system on the processor, all system events generated during running of the device. Therefore, the processor needs to have a powerful data processing capability and remain in a working state during the running of the device. However, the electronic device only needs to realize some functions that require low processing performance in most cases in daily use. Taking a smartwatch or a smart wristband as examples, the smartwatch or the smart wristband only needs to perform a time display and message prompt in most cases. Therefore, the processor remaining in the working state for a long time does not improve the performance of the electronic device, but increases the power consumption of the device, resulting in a shorter battery life of the electronic device (especially on a wearable device with small battery capacity).

In order to reduce the power consumption of the electronic device while ensuring the performance of the electronic device, in a possible embodiment, the electronic device is configured with at least a first processor and a second processor that have different processing performances and power consumption. The first processor is configured to run the first system, and the second processor is configured to run the second system (namely, a dual-core dual system). A set of system switching mechanisms is designed for the dual-core dual-system.

During the running of the electronic device, the first system is run by a processor with low-power consumption to process an event that requires low processing performance, and a processor with high-power consumption remains in a sleep state (correspondingly, the second system ran by the processor with high-power consumption is in the sleep state), thus reducing power consumption of the electronic device while realizing a basic function of the electronic device. When an event that require high processing performance occurs (for example, when an application program is started), the processor with high-power consumption is woken up and the second system is switched to process the event, so as to ensure that a triggered event can be responded to and processed in time to satisfy a performance requirement of the electronic device.

In order to facilitate a user to quickly start an application in the second system, the application in the second system supports starting from the first system. For example, for a smartwatch, a widget is arranged on a watch-face interface of the first system, and the user may quickly start an application corresponding to the widget of the second system by clicking the widget on the watch-face interface.

However, during the process of starting the application in the second system from the first system, when the second system is woken up to light up the screen, the second system may firstly draw an interface displayed before turning off the screen last time, and then draw an application interface of the application which should start. Therefore, it may generate the problem of flashing the interface displayed by the second system before turning off the screen last time during the application starting process, affecting the smoothness of the interface switching during the application starting process.

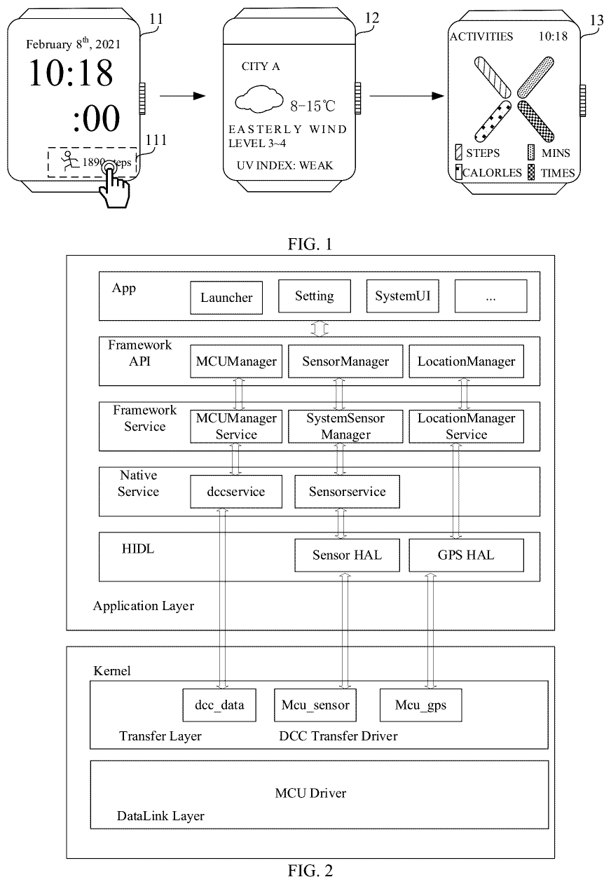

Exemplarily, as illustrated in FIG. 1, when the user clicks on a sports widget 111 on the watch-face interface 11 displayed on the smartwatch, and an interface displayed by the second system before turning off the screen last time is a weather application interface 12, a change process of content displayed on the smartwatch is: the watch-face interface 11→the weather application interface 12→a sports application interface 13, during a process of starting a sports application.

In order to achieve smooth switching of the interface during the application starting process, some embodiments of the present disclosure introduce a mechanism of turning off screen refresh. When an application starting operation of starting a target application which starts from the first system and runs in the second system is received, a screen refresh function remains turned off before the second system completes drawing the target interface (a system interface of the first system or an application interface of the target application), and the screen refresh function is turned on when the second system completes drawing the target interface. Since the screen refresh remains turned off when drawing the interface displayed by the second system before turning off the screen last time is completed, the electronic device does not display the interface displayed by the second system before turning off the screen last time. Instead, the electronic device keeps displaying the content that was displayed before starting the application operation. In this way, it may reduce an occurrence of flashing the interface displayed by the second system before turning off the screen last time during the application starting process.

In some embodiments of the present disclosure, the first processor and the second processor work asynchronously, and the first system and the second system need to realize system communication (or referred to as dual-core communication). In a possible application scenario, the first system is a real-time operating system (RTOS) run by a micro control unit (MCU), and the second system is an Android operating system run by a central processing unit (CPU).

As illustrated in FIG. 2, FIG. 2 illustrates a dual-core communication software framework of the Android operating system according to some embodiments of the present disclosure. The dual-core communication software framework adheres to the design principles of “low coupling, high reliability, and high multiplexing”, and includes developments of a kernel module, a hardware abstraction layer interface definition language (HIDL) module, a native service module, a framework service module, a framework application programming interface (API) module, and an application (APP) module.

The APP module includes functional modules such as a launcher (desktop launcher), a setting, a system user interface (UI), or the like. The framework API module includes management modules such as an MCU manager, a sensor manager, a location manager, or the like. The framework service module includes service modules such as an MCU manager service, a system sensor manager, a location manager service, or the like. The native service module includes service modules such as a data call control service (dcc service), a sensor service, or the like. The HIDL module includes modules such as a sensor hardware abstraction layer (HAL), a global positioning system (GPS) HAL, or the like. The kernel module includes DCC transfer drivers such as dcc_data, Mcu_sensor, Mcu_gps, or the like.

A transport layer serves as an interface layer connecting an upper layer and a lower layer in a dual-core communication software framework. The transport layer is configured to shield a transport detail of communication at the lower layer (a data link layer) of a system from an application layer and provide a service channel for an application scenario. The application layer, as a main provider of services, is configured to respond to human-computer interaction, transmit data generated during human-computer interaction through a transmission layer, and respond to an external data request.

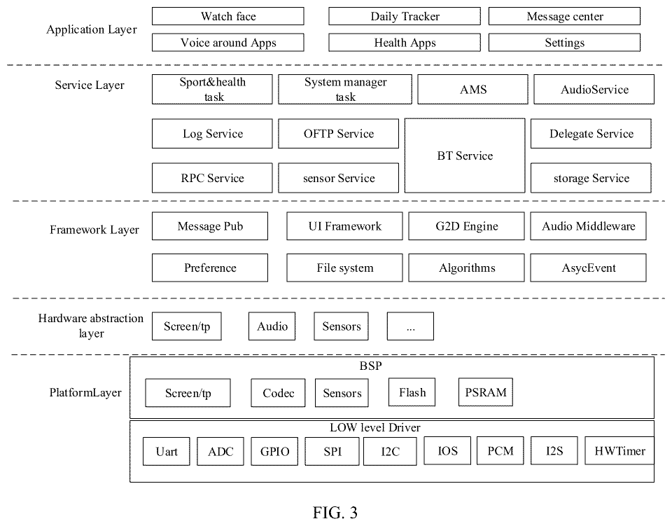

The RTOS is designed under the principle of equivalence. Taking the electronic device as a smartwatch as an example, as illustrated in FIG. 3, FIG. 3 illustrates a dual-core communication software framework of the RTOS according to some embodiments of the present disclosure.

The dual-core communication software framework of the RTOS is divided into an application layer, a service layer, a framework layer, a HAL, and a platform layer.

The application layer includes application modules such as a watch face, a daily tracker, a message center, voice around Apps, health Apps, settings, or the like. The service layer includes service modules such as a sport & health task, a system manager task, an activity management service (AMS), an audio service, a log service, an Odette file transfer protocol (OFTP) service, a Bluetooth (BT) service, a delegate service, a remote procedure call (RPC) service, a sensor service, a storage service, or the like. The framework layer includes framework modules such as a message pub, a UI framework, a graphics 2D (G2D) Engine, an audio middleware, a preference, a file system, algorithms, an AsycEvent, or the like. The HAL includes hardware abstraction modules such as a screen/touch panel (TP), sensors, keypad, motor, or the like. The platform layer includes a board support package (BSP) and a low-level driver, where the BSP includes a screen/TP, a codec, sensors, a flash, a pseudo static random access memory (PSRAM), or the like; and the low-level driver includes a universal asynchronous receiver/transmitter (Uart), an analog-to-digital converter (ADC), a general purpose input/output (GPIO), a serial peripheral interface (SPI), an inter-integrated circuit (I2C), an input/output system (IOS), a pulse-code modulation (PCM), an inter-IC sound (I2S), and a hardware (HW) timer.

The foregoing dual-core communication software framework is only used for exemplary description, and a person skilled in the art may add, delete or modify the foregoing framework according to actual requirements. The present disclosure does not limit a specific structure of the dual-core communication software framework.

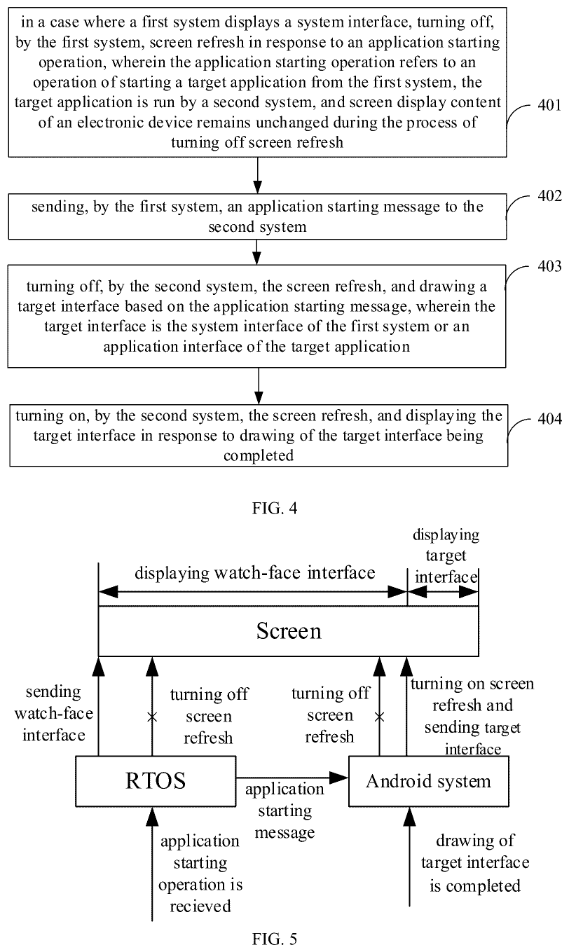

As illustrated in FIG. 4, FIG. 4 illustrates a flowchart of an application starting method according to an embodiment of the present disclosure. In the embodiment, for example, the method is applicable to an electronic device that supports running of a first system and a second system. The method may include the following operations.

At block 401, in a case where a first system displays a system interface, the first system turns off screen refresh in response to an application starting operation. The application starting operation refers to an operation of starting a target application from the first system, the target application is run by the second system, and screen display content of the electronic device remains unchanged during the process of turning off screen refresh.

In some embodiments, operating power consumption of the first system is lower than that of the second system.

In a possible embodiment, the electronic device is arranged with a first processor and a second processor. Processing performance of the first processor is lower than that of the second processor (both processing capacity and processing speed of the first processor are lower than those of the second processor), and power consumption of the first processor is lower than that of the second processor. Correspondingly, the second system (run by the second processor) is capable of processing an event processed by the first system (run by the first processor), and the first system may not be able to process the event processed by the second system.

In another possible embodiment, the electronic device may be arranged with a single processor. The first system and the second system are respectively run by different cores of the processor. The processing performance of a core running the second system is higher than processing performance of a core running the first system.

Taking the electronic device as a smartwatch as an example, the first processor is an MCU, the second processor is a CPU, the first system is a RTOS, and the second system is an Android system. Correspondingly, an event that may be processed by the first system includes scenarios requiring low processing performance or weak interaction scenarios, such as watch face display, watch-face interface switch, notification-and-message display, etc. An event that may be processed by the second system includes scenarios requiring high processing performance or strong interaction scenarios, such as incoming calls answering, application starting, watch-face editing, function setting, etc.

In a possible embodiment, a working mode of the electronic device may include a performance mode, a hybrid mode, or a low-power mode. In the performance mode, the second processor and the first processor both remain in the wake-up state (correspondingly, both the first system and the second system are in the wake-up state). In the low-power mode, only the first processor remains in the wake-up state, and the second processor is in an off state (that is, the first system is in the wake-up state, and the second system is in the off state). In the hybrid mode, the second processor is in a standby state and may switch between the sleep state and the wake-up state when the first system processes an event (that is, when the first system is in the wake-up state, the second system may be in the wake-up state or in the sleep state).

In some embodiments, in the wake-up state, system-related data is cached in a memory such as a random access memory (RAM) and can be run at any time. In the sleep state, most hardware modules of the processor are turned off, system-related data is stored in a hard disk such as a read-only memory (ROM), and the system-related data is written into the memory from the hard disk when the sleep state is switched to the wake-up state.

Unlike an electronic device with strong interaction such as a smartphone, the wearable device is an auxiliary electronic device and only has weak interactions with a user in most usage scenarios. For example, the user only raises their wrists to check the time or message prompt through the smartwatch in most scenarios. Therefore, the second processor is controlled to be in the sleep state (that is, the second system is controlled to be in the sleep state) to reduce overall power consumption of the wearable device when the wearable device processes the event by the first system. For convenience of description, the wearable device is taken as an example in the following embodiments.

In some embodiments, when the first system is in the wake-up state, the electronic device displays a system interface of the first system, for example, the wearable device displays the watch-face interface. In a possible application scenario, when the first system is in the wake-up state, the second system is in the sleep state. In another possible application scenario, when the first system is in the wake-up state, the second system is also in the wake-up state, and the first system is in a foreground running state, while the second system is in a background running state.

In some embodiments of the present disclosure, an application installed in the electronic device supports running in the second system and triggering starting from the first system. In some embodiments, an application that may supporting being triggered to start from the first system may be a default application or a user-customized application.

When the user wants to start the target application which starts from the first system and runs in the second system, the user may perform a specific application starting operation. In some embodiments, the application starting operation includes at least one of: a click operation on a widget of the first system, a key-pressing operation on a physical key, and a sliding operation on the system interface of the first system. The present disclosure does not limit a specific application starting operation.

When the application starting operation is received, the first system turns off screen refresh, so that screen display content of the electronic device remains unchanged. During the process of turning off screen refresh, the first system may stop uploading new image data to a screen of the electronic device. In some embodiments, during a period when the screen refresh is turned off, the screen of the electronic device continuously displays the most recently uploaded frame image from the first system through a repeated refresh mechanism, thereby keeping the display content unchanged. The image is a screen displayed by the electronic device when the application starting operation is received by the electronic device. For example, the image is the system interface of the first system.

Taking the electronic device as the smartwatch, the first system is an RTOS, and the second system is an Android system. For example, as illustrated in FIG. 5, the RTOS is in a wake-up state and controls a screen to display a watch-face interface. When the RTOS receives the application starting operation (a click operation on a widget of the watch-face interface corresponding to the RTOS, or a key-pressing operation on a watch crown), the RTOS system turns off the screen refresh. Since the RTOS transmits image data of the watch-face interface to the screen before receiving the application starting operation, the smartwatch may remain displaying the watch-face interface after the screen refresh is turned off.

At block 402, the first system sends an application starting message to the second system.

In a possible embodiment, the first system sends the application starting message to the second system in a manner of a dual-core communication. The application starting message at least includes application starting data configured to indicate the target application which should start.

It should be noted that if the second system is in a sleep state, the first system needs to wake up the second system firstly. The first system may wake up the second system in a manner of sending an interrupt, which is not limited herein.

Exemplarily, as illustrated in FIG. 5, the RTOS sends an application starting message to the Android system in the manner of a dual-core communication after receiving the application starting operation.

At block 403, the second system turns off the screen refresh and draws a target interface based on the application starting message. The target interface is the system interface of the first system or an application interface of the target application.

In order to reduce an occurrence of flashing the interface displayed before turning off a screen last time during the application starting process by the electronic device, the second system also turns off the screen refresh in the wake-up state. That is, the second system may not upload drawn image data to the screen of the electronic device, so that the electronic device may continue to keep the screen display content unchanged.

In some embodiments of the present disclosure, the second system in the wake-up state draws the target interface according to an animation display requirement during the application starting process. The target interface may be the system interface of the first system (i.e., an interface currently displayed by the electronic device), or the application interface of the target application (usually referring to a first frame image of the target application).

Exemplarily, as illustrated in FIG. 5, after receiving the application starting message, the Android system turns off the screen refresh in the wake-up state and draws the target interface. During a period when the screen refresh is turned off by the Android system, the screen of the electronic device continues to display the watch-face interface.

At block 404, when drawing of the target interface is completed, the second system turns on the screen refresh and displays the target interface.

In some embodiments, when the target interface is the system interface of the first system, the second system further needs to draw the application interface of the target application for being subsequent displayed after completing the drawing of the system interface.

Before the drawing of the target interface is completed, the screen refresh of the second system remains turned off. When the drawing of the target interface is completed, in order to display the target interface, the second system turns on the screen refresh and displays the target interface through the screen.

The interface displayed before turning off the screen last time is firstly drawn when the second system is in the wake-up state, and the drawing of the target interface is not completed when the drawing of the interface displayed before turning off the screen last time is completed. Therefore, the drawn interface displayed before turning off the screen last time is not uploaded to the screen, so as to reduce an occurrence of flashing the interface displayed by the second system before turning off the screen last time.

Exemplarily, as illustrated in FIG. 5, when the drawing of the target interface is completed, the Android system turns on the screen refresh and uploads the drawn target interface to the screen for display. It can be seen that after introducing the mechanism of turning off screen refresh, it may be possible to reduce an occurrence of flashing the interface displayed by the second system before turning off the screen last time.

In conclusion, in some embodiments of the present disclosure, for the electronic device supporting dual systems, when the electronic device receives the application starting operation of starting the target application which starts from the first system and runs in the second system, the screen refresh function remains being turned off before the second system completes the drawing of the target interface, and the screen refresh function is turned on when the second system completes the drawing of the target interface. That is, the electronic device remains the display content unchanged before the drawing of the target interface is completed. In this way, it may be possible to reduce an occurrence of flashing the interface displayed by the second system before turning off the screen last time during the application starting process, thereby achieving smooth switching between interfaces during the application starting process.

In some embodiments, the sending, by the first system, an application starting message to the second system, includes: sending, by the first system, the application starting message to the second system based on a support status of the target application for a transition animation. The transition animation refers to an animation transitioning from the system interface to the application interface.

In some embodiments, in response to the transition animation being turned off, the application starting message includes application starting data. In some embodiments, in response to the transition animation being turned on, the application starting message includes application starting data and interface data.

In some embodiments, the application starting data is configured to represent the target application which should start. The interface data is configured to draw the system interface of the first system.

In some embodiments, in a case where the target application does not support transition animation, the drawing a target interface based on the application starting message, includes: drawing, by the second system, the application interface of the target application based on the application starting data; and the turning on, by the second system, the screen refresh, and displaying the target interface in response to drawing of the target interface being completed, includes: turning on, by the second system, the screen refresh, and displaying the application interface in response to drawing of the application interface of the target application being completed.

In some embodiments, in a case where the target application supports the transition animation, the drawing a target interface based on the application starting message, includes: drawing, by the second system, the system interface of the first system based on the interface data; and the turning on, by the second system, the screen refresh, and displaying the target interface, in response to drawing of the target interface being completed, includes: turning on, by the second system, the screen refresh, and displaying the system interface, in response to drawing of the system interface of the first system being completed.

In some embodiments, after the drawing, by the second system, the system interface of the first system based on the interface data, the application starting method further includes: drawing, by the second system, the application interface of the target application based on the application starting data; and displaying, by the second system, the transition animation based on the system interface and the application interface.

In some embodiments, in a case where the target application supports the transition animation, the application starting method further includes: generating, by the first system, the interface data based on the system interface. The interface data is in a form of an image or a file, and the interface data in the form of the file includes control layout information and a resource file of the system interface.

In some embodiments, the application starting method further includes: sending, by the second system, a state update message to the first system, where the state update message is configured to represent the updated support status of the application for the transition animation; and updating, by the first system, the support status of the application for the transition animation based on the state update message.

In some embodiments, the turning off, by the second system, the screen refresh, and drawing a target interface based on the application starting message, includes: obtaining, by the second system, a screen control authority from the first system; and in response to obtaining the screen control authority, turning off, by the second system, the screen refresh and drawing the target interface based on the application starting message.

In some embodiments, after the sending, by the first system, an application starting message to the second system, the application starting method further includes: drawing, by the second system, a history interface, where the history interface is an interface displayed by the second system before turning off a screen last time, and the history interface is drawn before drawing the target interface; or cancelling, by the second system, drawing a history interface in response to the application starting message being identified.

In some embodiments, the application starting operation includes at least one of: a key-pressing operation on a physical key, a click operation on a widget of the first system, and a sliding operation on the system interface of the first system.

In some embodiments, operating power consumption of the first system is lower than that of the second system.

In some embodiments, after the first system sends the application starting message to the second system, the second system may firstly draw a history interface before the second system draws the target interface. The history interface is an interface displayed by the second system before turning off the screen last time. Since the drawing of the target interface is not completed when the drawing of the history interface is completed, the screen refresh is still in the turned-off state. Accordingly, the history interface is not uploaded to the screen of the electronic device.

In some embodiments, in order to reduce unnecessary interface drawing, in a case where the application starting message is identified by the second system, the drawing of the history interface is cancelled, while the target interface is drawn directly. In this way, it may be possible to reduce the waste of processing resources caused by the unnecessary interface drawing.

In an actual application process, the user may set the transition animation to be displayed during the application starting process, or not display the transition animation (which may be used for some applications or all applications) according to the needs. When the application in the second system is started from the first system, the transition animation refers to an animation transiting from the system interface of the first system to the application interface.

In a possible embodiment, the support status of the application for the transition animation is kept in the first system. When the application starting operation is received, the first system sends the application starting message to the second system based on the support status of the target application for the transition animation. Contents of the application starting message sent by the first system is also different from each other under the support status and an unsupported status.

In some embodiments, the support status of the application for the transition animation may be set uniformly through a transition animation switch. That is, whether all applications support or do not support the transition animation is controlled by the transition animation switch. In some embodiments, the support status for transition animation may also be a default property of the application (i.e., modification being supported or not supported). That is, some applications support the transition animation, and some applications do not support the transition animation, which is not limited herein this embodiment.

Exemplary embodiments are described below for illustrate the application starting process in two scenarios where the target application supports the transition animation and the target application does not support the transition animation, respectively.

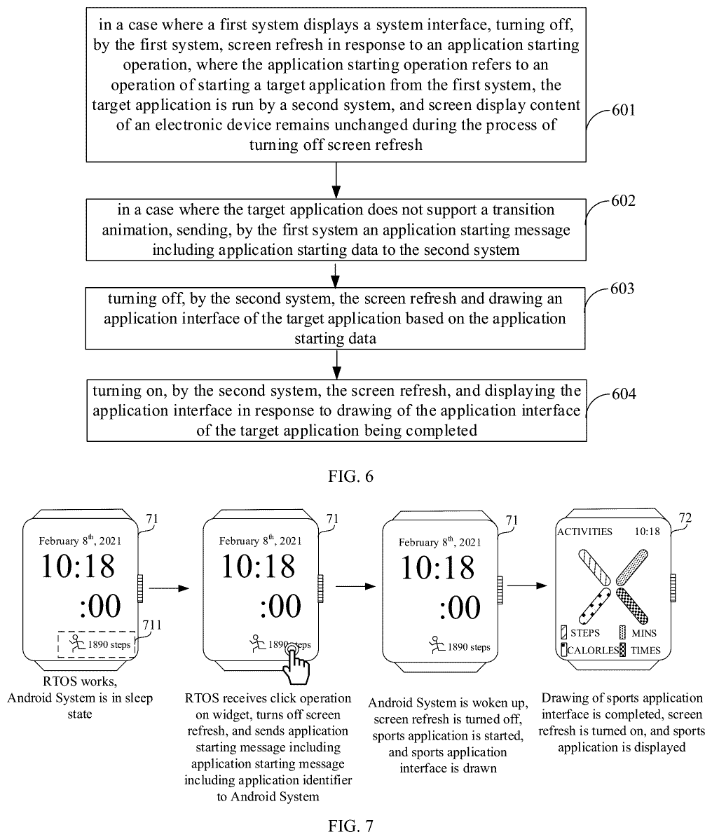

As illustrated in FIG. 6, FIG. 6 illustrates a flowchart of an application starting method according to another embodiment of the present disclosure. In the embodiment, for example, the method is applicable to an electronic device that supports running of a first system and a second system. The method may include the following operations.

At block 601, in a case where a first system displays a system interface, the first system turns off screen refresh in response to an application starting operation. The application starting operation refers to an operation of starting a target application from the first system, the target application is run by the second system, and screen display content of the electronic device remains unchanged during the process of turning off screen refresh.

The embodiment of the block 601 may refer to the foregoing block 401, which is not be repeated herein.

At block 602, in a case where the target application does not support transition animation, the first system sends an application starting message including application starting data to the second system.

In a possible embodiment, a switch state of the transition animation is kept in the first system. When the application starting operation is received and it is detected that the transition animation is in a turned-off state, since the second system does not need to display the animation transiting from the system interface of the first system to the application interface, the application starting message sent by the first system to the second system needs to include the application starting data representing the target application which should start.

In some embodiments, the application starting data may be an application identifier of the target application, or operation data of the application starting operation. For example, the operation data may be the number of pressing times of the key-pressing operation or a sliding direction of a sliding operation. The second system may be configured to determine the target application based on a mapping relationship between the operation data and the application identifier.

In some embodiments, when the application starting operation is a touch operation, the first system determines a control where a display area intersects with a touch area based on the touch area of the touch operation, and determines an application corresponding to the control as the target application. In this way, the application identifier of the target application may be determined as the application starting data.

In some embodiments, when the application starting operation is the key-pressing operation, the first system determines the target application corresponding to the number of pressing times based on the number of pressing times of the key-pressing operation (the first system stores a corresponding relationship between the number of pressing times and the application), so that the application identifier of the target application may be determined as the application starting data. In some embodiments, the first system takes the number of pressing times (i.e., the operation data of the application starting operation) as an application starting parameter, and the second system is configured to determine the target application based on the number of pressing times.

In some embodiments, when the application starting operation is the sliding operation, the first system is configured to determine the target application corresponding to a sliding parameter (the first system stores a corresponding relationship between the sliding parameter and the application) based on the sliding parameter of the sliding operation (such as the sliding direction), so that the application identifier of the target application may be determined as the application starting data. In some embodiments, the first system takes the sliding parameter (i.e., the operation data of the application starting operation) as the application starting parameter, and the second system is configured to determine the target application based on the sliding parameter.

It should be noted that the embodiments are described schematically only by taking the foregoing application starting operation and application starting data as examples, which, however, shall not be construed as a limitation thereon.

Exemplarily, as illustrated in FIG. 7, when the RTOS is in a working state and the Android system is in a sleep state, the smartwatch displays the watch-face interface 71 of the RTOS, and the watch-face interface 71 displays the widget 711 corresponding to a sports application. When a click operation on the widget 711 is received, the RTOS turns off the screen refresh and sends an application starting message including an application identifier corresponding to the sports application to the Android system. During a period when the screen refresh is turned off by the RTOS, the smartwatch continues to display the RTOS watch-face interface 71.

At block 603, the second system turns off the screen refresh and draws the application interface of the target application based on the application starting data.

Since the screen control authority of the electronic device is currently held by the first system, the second system needs to obtain the screen control authority from the first system. In addition, when the screen control authority is obtained, the second system turns off screen refresh. After obtaining the screen control authority, the second system can control the screen refresh on/off.

In some embodiments, the second system determines the target application which should start based on the application starting data included in the application starting message, so as to start the target application.

Exemplarily, as illustrated in FIG. 7, after receiving the application starting message sent by the RTOS, the Android system switches from the sleep state to the wake-up state, and obtains the screen control authority from the RTOS, so as to turn off the screen refresh.

Since it is not necessary to display the transition animation, the second system draws the application interface of the target application during the target application starting process.

The application interface is a first frame screen of the target application.

It should be noted that during the target application staring process, the second system needs to perform other necessary operations before displaying the application, such as a lighting-up screen operation. The lighting-up screen operation refers to an operation on the software layer, and includes a starting operation of lighting up screen on a framework layer, a screen state setting operation (i.e., changing the screen state corresponding to the second system from off to on), and so on, which is not limited in this embodiment.

Exemplarily, as illustrated in FIG. 7, the Android system starts a sports application based on the application identifier of the application starting message, and draws a sports application interface. Before the drawing of the sports application interface is completed, the smartwatch continues to display the watch-face interface 71 of the RTOS because the Android system turns off the screen refresh.

At block 604, when the drawing of the application interface of the target application is completed, the second system turns on the screen refresh and displays the application interface.

In a possible embodiment, the second system detects in real time whether the drawing of the application interface of the target application is completed. The second system turns on the screen refresh again when detecting that the drawing thereof is completed. After the screen refresh is turned on, the second system may upload the drawn application interface to the screen, so as to render and display the application interface through the screen.

Exemplarily, as illustrated in FIG. 7, when the drawing of the sports application interface is completed, the Android system turns on the screen refresh and uploads the image data of the sports application interface to the screen. After the screen receives the image data reported by the Android system, content currently displayed on the screen may be updated from the watch-face interface 71 to a sports application interface 72.

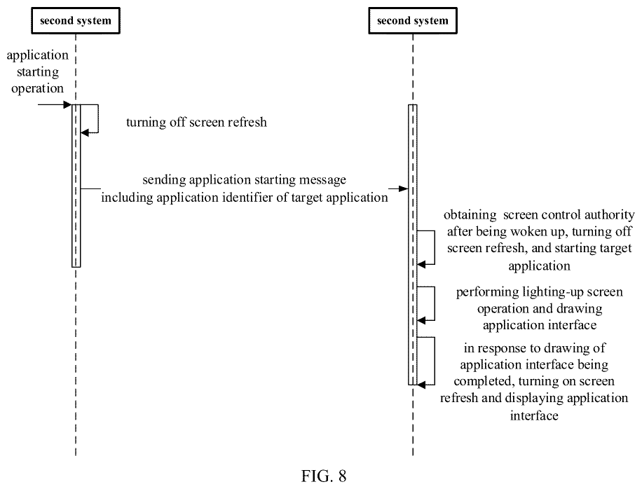

As illustrated in FIG. 8, the first system is in the wake-up state, and the second system is in the sleep state. When the application starting operation is monitored, the first system turns off the screen refresh and sends the application starting message including the application identifier of the target application to the second system.

After the application starting message is received by the second system, the second system switches from the sleep state to the wake-up state, and obtains the screen control authority, so as to turn off she screen refresh. The second system starts the target application based on the application identifier. During the application starting process, the second system draws the application interface and performs the lighting-up screen operation. When the lighting-up screen operation is completed and the drawing of the application interface is completed, the second system may turn on the screen refresh and display the drawn application interface through the screen.

In the embodiment, when the transition animation is turned off, the first system sends the application starting message including the application starting data to the second system. The second system starts the target application based on the application starting data and draws the application interface of the target application. Therefore, when the drawing of the application interface is completed, the screen refresh is turned on again and the application interface is displayed. Since the screen refresh is in the turned-off state before the drawing of the application interface is completed, the interface, which is displayed by the second system before turning off the screen last time, is not flashed during a process of the system interface of the first system switching to the application interface. In this way, it may be possible to improve the smoothness of interface switching during the application starting process.

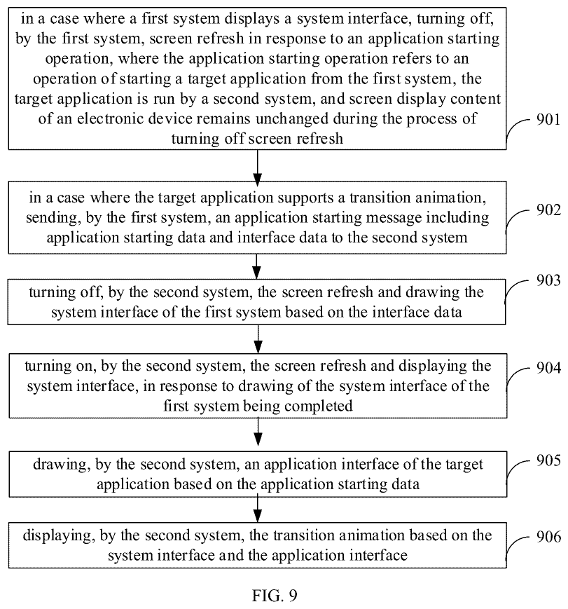

As illustrated in FIG. 9, FIG. 9 illustrates a flowchart of an application starting method according to yet another embodiment of the present disclosure. In the embodiment, for example, the method is applicable to an electronic device that supports running of a first system and a second system. The method may include the following operations.

At block 901, in a case where a first system displays a system interface, the first system turns off screen refresh in response to an application starting operation. The application starting operation refers to an operation of starting a target application from the first system, the target application is run by the second system, and screen display content of the electronic device remains unchanged during the process of turning off screen refresh.

The embodiment of the block 901 may refer to the foregoing block 401, which is not be repeated herein.

At block 902, in a case where the target application supports transition animation, the first system sends an application starting message including application starting data and interface data to the second system.

In a possible embodiment, a switch state of the transition animation is kept in the first system. When the application starting operation is received and it is detected that the transition animation is in a turned-on state, since the second system needs to display the animation transiting from the system interface of the first system to the application interface, the application starting message sent by the first system to the second system needs to not only include the application starting data representing the target application which should start, but also include the interface data. The interface data is configured to draw the system interface of the first system.

The embodiment of the block 902 may refer to the foregoing block 602, which is not be repeated herein.

In some embodiments, when it is determined that the target application supports the transition animation, the first system first generates the interface data based on the system interface. The interface data is in a form of an image or a file. The interface data in the form of the file includes control layout information and a resource file of the system interface. Correspondingly, when the interface data is in the form of an image, the system interface may be obtained by directly drawing the interface data in an image form. When the interface data is in the form of the file, each control is drawn based on the resource file, the drawn control is laid out based on control layout information, and the system interface is obtained.

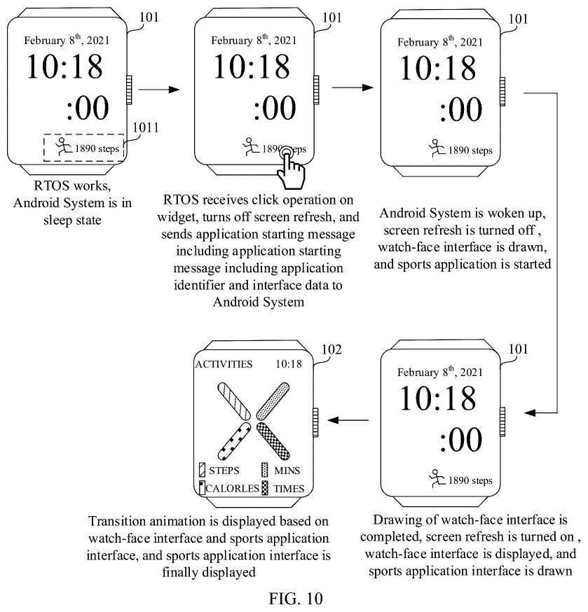

Exemplarily, as illustrated in FIG. 10, when the RTOS is in a working state and the Android system is in a sleep state, the smartwatch displays the watch-face interface 101 of the RTOS, and the watch-face interface 101 displays the widget 1011 corresponding to a sports application. When a click operation on the widget 1011 is received, the RTOS turns off the screen refresh and sends an application starting message including an application identifier corresponding to the sports application to the Android system. During a period when the screen refresh is turned off by the RTOS, the smartwatch continues to display the RTOS watch-face interface 101.

At block 903, the second system turns off the screen refresh and draws the system interface of the first system based on the interface data.

In a possible embodiment, when the second system receives the application starting message sent by the first system, and it is detected that the application starting message includes the interface data, the system interface of the first system is firstly drawn based on the interface data, so that the transition animation may be displayed subsequently based on the system interface.

Exemplarily, as illustrated in FIG. 10, after the application starting message sent by the RTOS is received by the Android system, the Android system switches from the sleep state to the wake-up state, and obtains the screen control authority from the RTOS to turn off the screen refresh. The Android system starts the sports application based on the application identifier of the application starting message, and firstly draws the watch-face interface based on the interface data. Before the drawing of the watch-face interface is completed, the smartwatch continued to display the watch-face interface 101 of the RTOS because the Android system turns off screen refresh.

At block 904, in response to drawing of the system interface of the first system being completed, the second system turns on the screen refresh and displays the system interface.

In a possible embodiment, the second system detects in real time whether the drawing of the system interface is completed. The second system turns on the screen refresh again when detecting that the drawing thereof is completed. After the screen refresh is turned on, the second system may upload the drawn system interface to the screen, so as to render and display the system interface through the screen.

Exemplarily, as illustrated in FIG. 10, when the drawing of the watch-face interface is completed, the Android system turns on the screen refresh and uploads the image data of the watch-face interface to the screen. After receiving the image data reported by the Android system, the screen renders and displays the watch-face interface 101. It should be noted that although the display content of the screen is the same as that displayed before and after the screen refresh is turned on/turned off, however, the watch-face interface, which is displayed during a period when the screen refresh is turned off, is rendered based on the image data reported by the first system, while the watch-face interface displayed after the screen refresh is turned on is rendered based on the image data reported by the second system.

At block 905, the second system draws the application interface of the target application based on the application starting data.

In a possible embodiment, the second system draws the application interface of the target application after the drawing of the system interface is completed.

Exemplarily, as illustrated in FIG. 10, when the Android system completes the drawing the watch-face interface and displays the watch-face interface, the Android system continues to draw the sports application interface of the sports application.

At block 906, the second system displays the transition animation based on the system interface and the application interface.

When the drawing of the application interface is completed, the second system displays the transition animation based on the drawn system interface and the drawn application interface. In some embodiments, the transition animation may be an animation in which the system interface is gradually scaled down and the application interface is gradually scaled up.

In some embodiments, the transition animation may be an animation in which the system interface is gradually slid out and the application interface is gradually slid in. In some embodiments, the transition animation may be an animation in which the system interface gradually blurs and the application interface gradually becomes clear. The specific effect of the transition animation is not limited herein.

Exemplarily, as illustrated in FIG. 10, after the Android system completes the drawing of the sports application interface, the transition animation is displayed based on the watch-face interface and the sports application interface, and the sports application interface 102 is displayed finally.

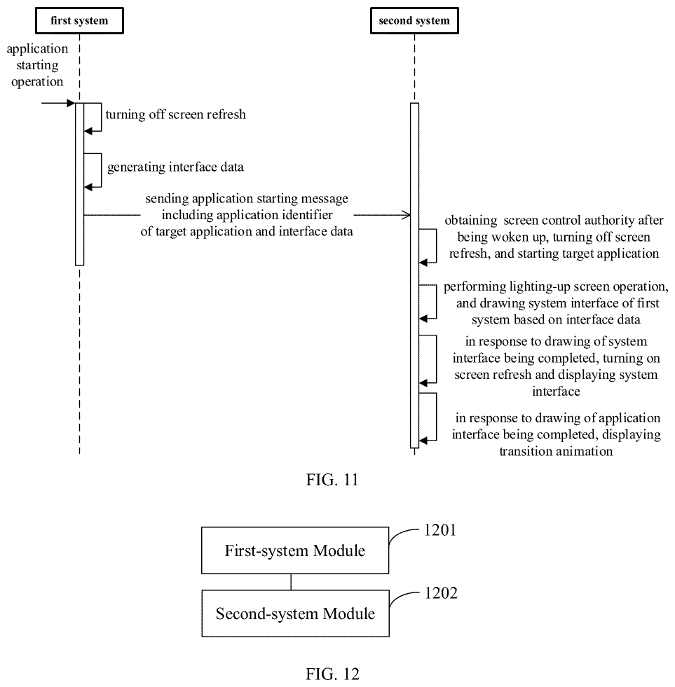

As illustrated in FIG. 11, the first system is in the wake-up state, and the second system is in the sleep state. When the application starting operation is monitored, the first system turns off the screen refresh and generates the interface data based on the system interface of the first system, so as to send the application starting message including the application identifier and the interface data to the second system.

After the application starting message is received by the second system, the second system switches from the sleep state to the wake-up state, and obtains the screen control authority, so as to turn off she screen refresh. Further, the second system starts the target application based on the application identifier. The second system firstly draws the system interface of the first system based on the interface data, and performs the lighting-up screen operation during a drawing process. When the lighting-up screen operation is completed and the drawing of the system interface is completed, the second system may turn on the screen refresh and display the drawn system interface of the first system through the screen. The second system continues to draw the application interface of the target application and displays the transition animation based on the system interface and application interface. After the transition animation is completed, the second system finally displays the application interface of the target application.

In this embodiment, when the transition animation is turned on, the first system sends the application starting message including application starting data and interface data to the second system. The second system starts the target application based on the application starting data and draws the system interface of the first system based on the interface data. When the drawing of the system interface is completed, the screen refresh is turned on again and the system interface is displayed. When the drawing of the application interface of the target application is completed, the second system displays the transition animation based on the system interface and the application interface, thereby completing the application starting. Since the screen refresh is in the turned-off state before the drawing of the system interface is completed, the interface, which is displayed by the second system before turning off the screen last time, is not flashed during a switching process. In this way, it may be possible to improve the smoothness of interface switching during the application starting process.

The user may freely set whether the application supports the transition animation according to needs. In a possible embodiment, when receiving a state update operation, the second system sends a state update message to the first system. The state update message is configured to represent the updated support status of the application for the transition animation. The state update message may indicate to update the support status of all applications for the transition animation, or update the support status of a specific application for the transition animation. For example, the state update operation may be a trigger operation of setting the control for the transition animation switch, and may be configured to indicate to update the support status of all applications for the transition animation.

Correspondingly, the first system updates the support status of the application for the transition animation based on the state update message, so that content, which required to be included in the application starting message sent to the second system, may be determined subsequently based on an updated support status.

In other possible embodiments, the process of displaying the transition animation requires a certain amount of processing resources. Therefore, when the device power of the electronic device is higher than a power threshold (such as 30%), and the application supports the transition animation, the first system sends an application starting message including the application starting data and the interface data to the second system. When the device power of the electronic device is lower than the power threshold, even if the application supports the transition animation, the first system only sends the application starting message including the application starting data to the second system.

It should be noted that, in each of the above embodiments, only the display process of the application interface in a dual-core dual-system device is used as an example for illustration. In other possible application scenarios, single-core dual-system devices (such as different systems running on different cores of a processor) can also use the solution according to the embodiment of the present disclosure for displaying the application interface during the system switching process, and details thereof will be omitted here.

As illustrated in FIG. 12, FIG. 12 illustrates a structural block diagram of an application starting apparatus according to another embodiment of the present disclosure. The apparatus may be implemented as all or part of an electronic device by software, hardware, or a combination of both. The apparatus includes a first-system module 1201 and a second-system module 1202.

The first-system module 1201 is configured to turn off screen refresh in response to an application starting operation, in a case where the first system displays a system interface. The application starting operation refers to an operation of starting a target application from the first system, the target application is run by the second system, and screen display content of the electronic device remains unchanged during the process of turning off screen refresh.

The first-system module 1201 is configured to send an application starting message to the second-system module 1202.

The second-system module 1202 is configured to turn off the screen refresh and draw a target interface based on the application starting message. The target interface is the system interface of the first-system module or the application interface of the target application.

The second-system module 1202 is configured to turn on the screen refresh and display the target interface when the drawing of the target interface is completed.

In some embodiments, the first-system module 1201 is configured to send the application starting message to the second-system module 1202 based on a support status of the target application for a transition animation. The transition animation refers to an animation transitioning from the system interface to the application interface.

In some embodiments, in response to the transition animation being turned off, the application starting message includes application starting data. In some embodiments, in response to the transition animation being turned on, the application starting message includes application starting data and interface data.

In some embodiments, the application starting data is configured to represent the target application which should start. The interface data is configured to draw the system interface of the first-system module.

In some embodiments, in a case where the target application does not support the transition animation, the second-system module 1202 is configured to draw the application interface of the target application based on the application starting data; and the second-system module 1202 is further configured to turn on the screen refresh and display the application interface in response to drawing of the application interface of the target application being completed in response to drawing of the application interface of the target application being completed.

In some embodiments, in a case where the target application supports the transition animation, the second-system module 1202 is configured to draw the system interface of the first-system module based on the interface data; and the second-system module 1202 is further configured to turn on the screen refresh and display the system interface in response to drawing of the system interface of the first system being completed.

In some embodiments, the second-system module 1202 is further configured to draw the application interface of the target application based on the application starting data, and display the transition animation based on the system interface and the application interface.

In some embodiments, in a case where the target application supports the transition animation, the first-system module 1201 is further configured to generate the interface data based on the system interface. The interface data is in a form of an image or a file. The interface data is in a form of an image or a file, and the interface data in the form of the file includes control layout information and a resource file of the system interface.

In some embodiments, the second-system module 1202 is configured to send a state update message to the first-system module 1201. The state update message is configured to represent the updated support status of the application for the transition animation. The first-system module 1201 is configured to update the support status of the application for the transition animation based on the state update message.

In some embodiments, the second-system module 1202 is configured to obtain a screen control authority from the first-system module 1201, and turn off the screen refresh and draw the target interface based on the application launch message in response to obtaining the screen control authority.

In some embodiments, the second-system module 1202 is further configured to draw a history interface, where the history interface is an interface displayed by the second-system module before turning off a screen last time, and the history interface is drawn before drawing the target interface; or cancel drawing a history interface in response to the application starting message being identified.

In some embodiments, the application starting operation includes at least one of: a key-pressing operation on a physical key, a click operation on a widget of the first-system module, and a sliding operation on the system interface of the first-system module.

In some embodiments, operating power consumption of the first-system module 1201 is lower than that of the second-system module 1202.

In conclusion, in some embodiments of the present disclosure, for the electronic device supporting dual systems, when the electronic device receives the application starting operation of starting the target application which start from the first system and run in the second system, the screen refresh function remains being turned off before the second system completes the drawing of the target interface, and the screen refresh function is turned on when the second system completes the drawing of the target interface. That is, the electronic device remains the display content unchanged before the drawing of the target interface is completed. In this way, it may be possible to reduce an occurrence of flashing the interface displayed by the second system before turning off the screen last time during the application starting process, thereby achieving smooth switching between interfaces during the application starting process.

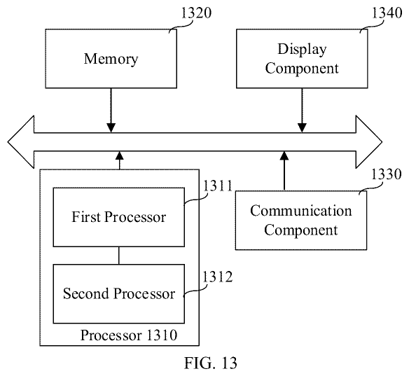

As illustrated in FIG. 13, FIG. 13 is a structural block diagram of an electronic device according to an embodiment of the present disclosure. The electronic device in some embodiments of the present disclosure may include one or more of the following components: a processor 1310 and a memory 1320.

In some embodiments, the processor 1310 at least includes a first processor 1311 and a second processor 1313. The first processor 1311 is configured to run the first system, and the second processor 1313 is configured to run the second system. The first processor 1311 has power consumption lower than the second processor 1313, and the first processor 1311 has a performance lower than the second processor 1313. The processor 1310 is configured to connect to each part of the whole electronic device via various interfaces and lines, to execute various functions of the electronic device and process data by running or executing an instruction, a program, a code set, or an instruction set that are all stored in the memory 1320 and invoking data stored in the memory 1320. Optionally, the processor 1310 may be implemented by using at least one hardware form of a digital signal processing (DSP), a field-programmable gate array (FPGA), or a programmable logic array (PLA). The processor 1310 may integrate one or any combination of a CPU, a graphic processing unit (GPU), a neural-network processing unit (NPU), a modem, or the like. The CPU is mainly configured to process an operating system, a UI, an application program, or the like. The GPU is configured to render and draw content required to be displayed on the TP. The NPU is configured to realize an artificial intelligence (AI) function. The modem is configured to process wireless communication. It should be understood that the modem may also not be integrated into the processor 1310 and may be implemented via a chip separately.

The memory 1320 may include the RAM or the ROM. Optionally, the memory 1320 may include a non-transitory computer-readable storage medium. The memory 1320 is configured to store an instruction, a program, a code, a code set, or an instruction set. The memory 1320 may include a program storage area and a data storage area. The program storage area is configured to store instructions for implementing the operating system, instructions for implementing at least one function (such as a touch control function, a sound playing function, an image playing function, or the like), instructions for implementing the above embodiments, or the like. The data storage area is configured to store data (such as audio data, phonebooks, or the like) created according to the usage of the wearable device.

The electronic device in embodiments of the present disclosure further includes a communication component 1330 and a display component 1340. The communication component 1330 may be a Bluetooth component, a wireless fidelity (Wi-Fi) component, a near field communication (NFC) component, or the like, and is configured to communicate with an external device (a server or other terminal devices) via a wired network or a wireless network. The display component 1340 is configured to display the GUI and/or receive a user interaction operation.

In addition, those skilled in the art can understand that the structure of the electronic device illustrated in the foregoing figures does not constitute any limitation on the electronic device. The electronic device may include more or fewer components than illustrated or may combine certain components or have different configurations or arrangements of components. For example, the electronic device further includes components such as a radio frequency (RF) circuit, an input unit, a sensor, an audio circuit, a loudspeaker, a microphone, a power supply, or the like, which are not described herein again.

A computer-readable storage medium is further provided in embodiments of the present disclosure. The storage medium store at least one program, and the at least one program is configured to be executed by the processor to perform the application starting method as described in the foregoing embodiments.

A computer program product or computer program is further provided in embodiments of the present disclosure. The computer program product or computer program includes a computer instruction stored in a computer-readable storage medium. The computer instruction is configured to be read by the processor of the electronic device from the computer-readable storage medium, and the computer instruction, when executed by the processor, causes a terminal to perform the application starting method as described in the foregoing embodiments.

Those skilled in the art should understand that in one or more of the above embodiments, the functions described in embodiments of the present disclosure may be implemented by any one or any combination of a hardware, a software, or a firmware. When implemented by software, functions may be stored in the computer-readable medium or transmitted as one or more instructions or codes in the computer-readable medium. The computer-readable medium includes a computer storage medium and a communication medium. The communication medium includes any medium that facilitates the transfer of a computer program from one place to another place. The storage medium may be any available medium that can be accessed by a general-purpose computer or a special-purpose computer.

The above are only optional embodiments of the present disclosure and are not intended to limit the scope of protection of the present disclosure. any modification, equivalent arrangements, and improvement made within the spirit and principles of the present disclosure shall be included in the scope of protection of the present disclosure.

What is claimed is:

1. An application starting method, applicable to an electronic device, the electronic device supporting running of a first system and a second system, the method comprising:
sending, by the first system, an application starting message to the second system;
drawing, by the second system, a target interface based on the application starting message, wherein the target interface is a system interface of the first system or an application interface of a target application run by the second system;
displaying, by the second system, the target interface in response to drawing of the target interface being completed.

2. The method according to claim 1, wherein,
sending, by the first system, the application starting message to the second system, comprises:
in a case where the target application does not support a transition animation, sending, by the first system, the application starting message comprising application starting data to the second system; and/or,
in a case where the target application supports a transition animation, sending, by the first system, the application starting message comprising the application starting data and interface data to the second system;
wherein the transition animation refers to an animation transitioning from the system interface to the application interface, the application starting data including an application identifier of the target application, or operation data of the application starting operation, and the interface data is configured to draw the system interface of the first system.

3. The method according to claim 1, wherein drawing, by the second system, the target interface based on the application starting message, comprises:
turning off, by the second system, the screen refresh, and drawing the target interface based on the application starting message; and
displaying, by the second system, the target interface in response to drawing of the target interface being completed, comprises:
turning on, by the second system, the screen refresh, and displaying the target interface in response to drawing of the target interface being completed.

4. The method according to claim 1, wherein,
in a case where the target application does not support transition animation,
drawing, by the second system, the target interface based on the application starting message, comprises:
drawing, by the second system, the application interface of the target application based on application starting data; and
displaying, by the second system, the target interface in response to drawing of the target interface being completed, comprises:
displaying, by the second system, the application interface in response to drawing of the application interface of the target application being completed.

5. The method according to claim 1, wherein,
in a case where the target application supports transition animation,
drawing, by the second system, the target interface based on the application starting message, comprises:
drawing, by the second system, the system interface of the first system based on interface data; and
displaying, by the second system, the target interface, in response to drawing of the target interface being completed, comprises:
displaying, by the second system, the system interface, in response to drawing of the system interface of the first system being completed.

6. The method according to claim 5, wherein, after drawing, by the second system, the system interface of the first system based on interface data, the method further comprises:
drawing, by the second system, the application interface of the target application based on application starting data; and
displaying, by the second system, the transition animation based on the system interface and the application interface.

7. The method according to claim 3, wherein, in a case where the target application supports the transition animation, the method further comprises:
generating, by the first system, the interface data based on the system interface, wherein the interface data is in a form of an image or a file, and the interface data in the form of the file comprises control layout information and a resource file of the system interface.

8. The method as claimed in claim 2, further comprising:
sending, by the second system, a state update message to the first system, wherein the state update message is configured to represent the updated support status of the application for the transition animation; and
updating, by the first system, the support status of the application for the transition animation based on the state update message.

9. The method according to claim 1, wherein drawing, by the second system, the target interface based on the application starting message, comprises:
obtaining, by the second system, a screen control authority from the first system; and
drawing, by the second system, the target interface based on the application starting message.

10. The method according to claim 1, wherein after sending, by the first system, the application starting message to the second system, the method further comprises:
drawing, by the second system, a history interface, wherein the history interface is an interface displayed by the second system before turning off a screen last time, and the history interface is drawn before drawing the target interface; or
cancelling, by the second system, drawing a history interface in response to the application starting message being identified.

11. The method according to claim 1, wherein the application starting operation comprises at least one of: a key-pressing operation on a physical key, a click operation on a widget of the first system, and a sliding operation on the system interface of the first system.

12. The method according to claim 1, wherein operating power consumption of the first system is lower than that of the second system;
the method further comprises:
in a case where the second system is in a sleep state, waking up, by the first system, the second system before the first system sends an application starting message to the second system.

13. The method according to claim 2, wherein the transition animation comprises at least one of: an animation in which the system interface is gradually scaled down, an application interface is gradually scaled up, an animation in which the system interface is gradually slid out, and the application interface is gradually slid in.

14. The method according to claim 1, the method further comprises:
in a case where the first system displays a system interface, turning off, by the first system, screen refresh in response to an application starting operation, wherein the application starting operation refers to an operation of starting a target application from the first system, and screen display content of the electronic device remains unchanged during the process of turning off screen refresh.

15. The method according to claim 1, wherein the target interface being the system interface of the first system or an application interface of the target application, comprises:
the target interface is an interface currently displayed by the electronic device, or a first frame image of the target application.

16. The method according to claim 1, wherein
an application of the electronic device has a default property is configured to represent a support status of the application for a transition animation; and/or,
the method further comprises:
controlling, by the electronic device, all applications or a specific application support or do not support the transition animation by a transition animation switch.

17. An electronic device, comprising a processor and a memory, the memory storing at least one program, and the at least one program being configured to be executed by the processor to perform:
sending, by the first system, an application starting message to the second system;
drawing, by the second system, a target interface based on the application starting message, wherein the target interface is the system interface of the first system or an application interface of the target application run by the second system;
displaying, by the second system, the target interface in response to drawing of the target interface being completed.

18. The electronic device according to claim 17, wherein in sending, by the first system, the application starting message to the second system, the at least one program is configured to be executed by the processor to perform:
sending, by the first system, the application starting message comprising application starting data to the second system in a case where the target application does not support a transition animation; and/or
sending, by the first system, the application starting data and interface data to the second system in a case where the target application supports a transition animation;
wherein the transition animation refers to an animation transitioning from the system interface to the application interface, the application starting data including an application identifier of the target application, or operation data of the application starting operation, and the interface data is configured to draw the system interface of the first system.

19. The electronic device according to claim 17, wherein in drawing, by the second system, the target interface based on the application starting message, the at least one program is configured to be executed by the processor to perform:
turning off, by the second system, the screen refresh, and drawing a target interface based on the application starting message; and
in displaying, by the second system, the target interface in response to drawing of the target interface being completed, the at least one program is configured to be executed by the processor to perform:
turning on, by the second system, the screen refresh, and displaying the target interface in response to drawing of the target interface being completed.

20. A non-transitory computer-readable storage medium, the storage medium storing at least one program, the at least one program being configured to be executed by a processor to perform:
sending, by the first system, an application starting message to the second system;
drawing, by the second system, a target interface based on the application starting message, wherein the target interface is the system interface of the first system or an application interface of the target application;
displaying, by the second system, the target interface in response to drawing of the target interface being completed.
